(19) United States
(12) Patent Application Publication
(10) Pub. No.: US 2015/0131176 A1
(43) Pub. Date: May 14, 2015

(54) APPARATUS AND METHOD FOR CONTROLLING SIDE-VIEW MIRROR

(71) Applicant: Hyundai Motor Company, Seoul (KR)

(72) Inventor: Yong Seok Soh, Seongnam (KR)

(21) Appl. No.: 14/338,844

(22) Filed: Jul. 23, 2014

(30) Foreign Application Priority Data
Nov. 13, 2013 (KR) 10-2013-0137828

(51) Int. Cl. B60R 1/02; B60R 1/00

(52) U.S. Cl. CPC B60R 1/025; B60R 1/007
USPC 359/843

(57) ABSTRACT

An apparatus and method for controlling side-view mirrors are provided. The method includes determining, by a controller, whether a turn signal is input from vehicle information collected while a vehicle is traveling and detecting a traveling speed when a turn signal is input to determine a control mode of side-view mirrors based on the traveling speed of the vehicle. A position of a left or right side-view mirror is then adjusted based on the turn signal when the control mode of the side-view mirrors is set to a lane change mode the position of the left or right side-view mirror is adjusted when the control mode of the side-view mirrors is set to a vehicle turn mode.

### CROSS-REFERENCE TO RELATED APPLICATION

This application is based on and claims priority from Korean Patent Application No. 10-2013-0137828, filed on Nov. 13, 2013 in the Korean Intellectual Property Office, the disclosure of which is incorporated herein in its entirety by reference.

### BACKGROUND

1. Field of the Invention

The present invention relates to apparatus and method for controlling side-view mirrors, and more particularly, to apparatus and method for controlling side-view mirrors based on a turn signal or a traveling speed of a vehicle.

2. Description of the Prior Art

Side-view mirrors, typically disposed on both outer sides of vehicles, are parts that assist drivers by providing side views of the vehicles in the rear of or to the side of the vehicle being driven. Accordingly, a driver looks in the side-view mirrors to detect if a vehicle or a pedestrian is approaching from sides when changing a lane or entering a crossroad while driving. Since the view angles provided by side-view mirrors differ depending on driver's sitting heights or the lengths of legs, the drivers may manually adjust the side-view mirrors to desired positions before driving the vehicle. After a driver has once adjusted positions of side-view mirrors before driving the vehicle, it may be difficult to adjust the side-view mirrors while driving. Further, it may be difficult to adjust side-view mirrors merely for the short use of changing a lane or entering a crossroad.

### SUMMARY

Accordingly, the present invention provides an apparatus and method for controlling side-view mirrors which determine that a vehicle is changing a lane or making a turn based on the traveling speed of the vehicle when a turn signal is input and then automatically adjust the position of at least one of left and right side-view mirrors based on the determination.

In one aspect of the present invention, an apparatus for controlling side-view mirrors may include: a determiner configured to determine whether a turn signal is input from vehicle information collected while a vehicle is traveling; a mode decider configured to detect a traveling speed when a turn signal is input to decide a control mode of side-view mirrors based on the traveling speed of the vehicle; and a driver configured to adjust a position of a left or right side-view mirror based on the turn signal when the control mode of the side-view mirrors is set to a lane change mode, and to adjust the position of the left or right side-view mirror when the control mode of the side-view mirrors is set to a vehicle turn mode.

The mode decider may be configured to set the control mode of the side-view mirrors to the lane change mode when the traveling speed is greater than a predetermined threshold value with the turn signal input. The mode decider may be configured to set the control mode of the side-view mirrors to the vehicle turn mode when the traveling speed is less than a predetermined threshold value with the turn signal input. When the turn signal is input, the determiner may be configured to determine whether the input turn signal is a left turn signal or a right turn signal. The driver may be configured to adjust the position of the left side-view mirror when the control mode of the side-view mirrors is set to the lane change mode with the left turn signal input, and to adjust the position of the right side-view mirror when the control mode of the side-view mirrors is set to the lane change mode with the right turn signal input. The driver may be configured to change a view angle of a side-view mirror from a first angle determined on a line parallel to a side of the vehicle to a second angle moved from the first angle in the lateral direction, when the turn signal is input and the control mode of the side-view mirrors is detected.

The first angle may be formed by a first point at a first distance from a side-view mirror of the vehicle rearward and a second point at a second distance from the first point in the lateral direction of the vehicle, and the second angle may be formed by the second point and a third point at a third distance from the second point in the lateral direction of the vehicle. The driver may be configured to initialize the adjusted positions of the side-view mirrors when the operation of the control mode of the side-view mirrors is completed.

In another aspect of the present invention, a method of controlling side-view mirrors, may include: determining whether a turn signal is input while a vehicle is traveling; determining whether the input turn signal is a left turn signal or a right turn signal when a turn signal is input; comparing the traveling speed of the vehicle with a predetermined threshold value when the turn signal is input, and determining the control mode of the side-view mirrors based on the comparison result; and adjusting a position of a left or right side-view mirror based on the turn signal when the control mode of the side-view mirrors is set to a lane change mode, and adjusting the positions of the left and right side-view mirrors when the control mode of the side-view mirrors is set to a vehicle turn mode.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary diagram illustrating the configuration of an apparatus for controlling side-view mirrors according to an exemplary embodiment of the present invention;

FIG. 2 is an exemplary diagram that is referred to set a side-view mirror control angle of the apparatus for controlling side-view mirrors according to an exemplary embodiment of the present invention;

FIGS. 3A to 5C are exemplary diagrams that are referred to illustrate the operation of adjusting the positions of side-view mirrors of the apparatus for controlling side-view mirrors according to an exemplary embodiment of the present invention; and

FIG. 6 is an exemplary flowchart illustrating a method of controlling side-view mirrors according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Hereinafter, the present invention will be described in detail with reference to the accompanying drawings. Like reference numerals are given to like components in the drawings. Further, the detailed description on well-known functions and/or configurations will not be made. The parts that are needed to understand operation according to various exemplary embodiments are mainly described below and components that may make the subject matter unclear are not described. Further, some of the components may be exaggerated, removed, or schematically shown in the drawings. The drawings are not to scale and thus the following description is not limited by the relative sizes or gaps of the components in the drawings.

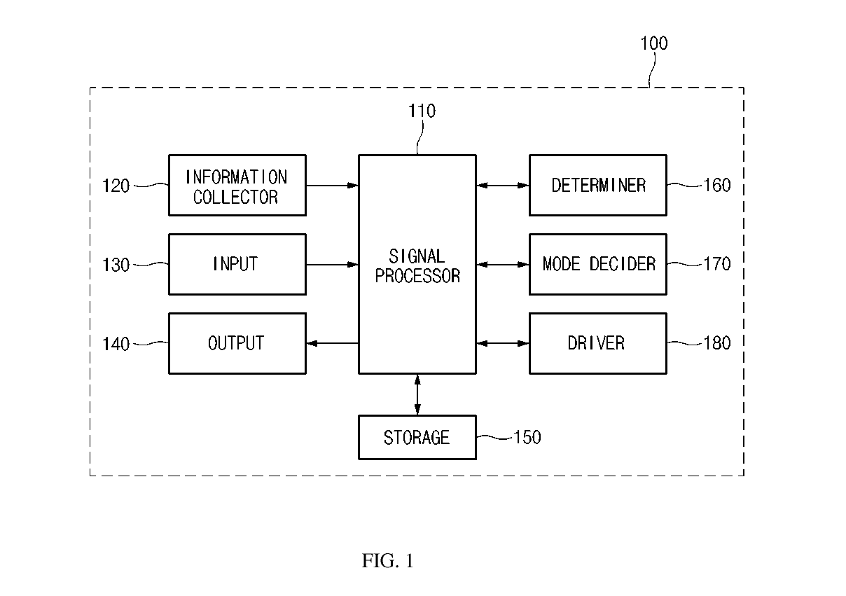

FIG. 1 is an exemplary diagram illustrating the configuration of an apparatus for controlling side-view mirrors according to an exemplary embodiment of the present invention. Referring to FIG. 1, an apparatus 100 for controlling side-view mirrors according to an exemplary embodiment of the present invention may include a signal processor 110, an information collector 120, an input 130, an output 140, a storage 150, a determiner 160, a mode decider 170, and a driver 180. The signal processor 110 may process signals transmitted among the units of the apparatus 100 for controlling side-view mirrors. That is, the processor 110 of a controller may be configured to operate the information collector 120, the input 130, the output 140, the storage 150, the determiner 160, the mode decider 170, and the driver 180

The information collector 120 may be configured to collect information generated in a traveling vehicle using at least one sensor disposed within the vehicle. For example, the information collector 120 may be configured to collect turn signal information generated by operation of a driver while a vehicle is traveling. Further, the information collector 120 may be configured to collect the information regarding the traveling speed of a traveling vehicle. The information collector 120 may also be configured to collect the information regarding the exterior around a traveling vehicle (e.g., in the vicinity of the traveling vehicle). For example, the information collector 120 may be configured to collect the information regarding vehicles surrounding the traveling vehicle.

The information collected by the information collector 120 may be transmitted to the signal processor 110 and the signal processor 110 may be configured to transmit the information collected by the information collector 120 to the components for side-view mirror control. For example, the signal processor 110 may be configured to transmit the turn signal information collected by the information collector 120 to the determiner 160 and the traveling speed information collected by the information collector 120 to the mode decider 170. In addition, the signal processor 110 may be configured to transmit the information collected by the information collector 120 to the components that operate for side-view mirror control, using corresponding information.

The input 130 may be a component configured to receive operation signals from a user. The input 130 described herein may be an operation unit on an instrument panel or an operation unit of a handle operation system. For example, a driver may input a left or right turn signal by operating a cruise controller on a side of the handle within a vehicle. The input 130 may be a component configured to receive control instructions from a user, and for example, the input 130 may be a soft key implemented on a touch panel monitor. A manager may input a set value for side-view mirror control through the input 130. In addition, the output 140 may be a component configured to output the operation state and the processing result of the apparatus 100 for controlling side-view mirrors. The output 140 described herein may be a built-in monitor of a vehicle or the screen of a navigation system. Further, the output 140 may include a voice output such as a speaker or a buzzer.

The storing unit 150 may be configured to store the set value for operating the apparatus 100 for controlling side-view mirrors. For example, the storing unit 150 may be configured to store a set value for determining the side-view mirror control mode of the apparatus 100 for controlling side-view mirrors, a set value for a lane change mode, and a set value for a vehicle turn mode. Further, the storing unit 150 may be configured to store an algorithm for the operation in the lane change mode or the vehicle turn mode. Additionally, the determiner 160 may be configured to determine whether a turn signal is input, from the information regarding a vehicle collected by the information collector 120 while the vehicle is traveling. When a turn signal is generated, the determiner 160 may be configured to determine whether the generated turn signal is the left turn signal or the right turn signal. The result of determining a turn signal by the determiner 160 may be used to decide a side-view mirror control mode in the mode decider 170.

The mode decider 170 may be configured to detect the traveling speed of a vehicle collected by the information collector 120, when the determiner 160 determines that a turn signal is input. In this process, the mode decider 170 may be configured to compare the collected traveling speed of the vehicle with a predetermined threshold value. When the traveling speed of the vehicle is greater than the threshold value, the mode decider 170 may be configured to determine that the input turn signal is for changing a lane with the vehicle driven and set the side-view mirror control mode to the lane change mode. When the traveling speed of the vehicle is the threshold value or less, the mode decider 170 may be configured to determine that the input turn signal is for turning the vehicle at a crossroad or the like and set the side-view mirror control mode to the vehicle turn mode.

The mode decider 170 may be configured to determine the side-view mirror control mode and transmit the result to the driver 180. Accordingly, the driver 180 may be configured to operate the apparatus 100 for controlling side-view mirrors in the lane change mode or the vehicle turn mode based on the determination by the mode decider 170. When the lane change mode is activated, the driver 180 may be configured to adjust the position of the side-view mirror for the corresponding direction based on the direction indicated by the turn signal determined by the determiner 160.

In other words, when a left turn signal is input, the driver 180 may be configured to adjust the position of the left side-view mirror. In the lane change mode, only the left view has to be ensured so that the vehicle changes the lane to the left, so the position of the left side-view mirror may be adjusted, while only the right view has to be ensured so that the vehicle changes the lane to the right, so the position of the right side-view mirror may be adjusted. Further, the driver 180 may be configured to adjust the positions of the left and right side-view mirror, while operating in the vehicle turning mode. In the vehicle turn mode, since both side views should be ensured, when the vehicle enters a crossroad to turn left or right, the driver may be configured to adjust the positions of the left and right side-view mirror regardless of the direction indicated by a turn signal.

When the driver 180 operates in the lane change mode or the vehicle turn mode, the driver 180 may be configured to adjust the positions of side-view mirrors in the lateral direction of the vehicle from an initially set position. In other words, when the driver 180 operates in the lane change mode or the vehicle turn mode, the driver 180 may be configured to adjust the view angles of side-view mirrors from a first angle set with respect to the direction parallel to the side of the vehicle to a second angle set in the lateral direction. The first angle may be formed by a first point at a first distance from a side-view mirror of a vehicle rearward and a second point at a second distance from the first point in the lateral direction of the vehicle. Further, the second angle may be formed by the second point and a third point at a third distance in the lateral direction of the vehicle.

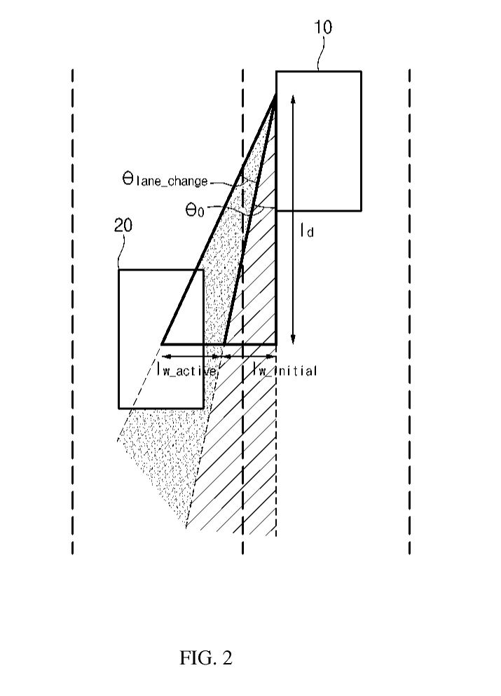

The operation of setting angles for adjusting the positions of side-view mirrors is described in more detail with reference to FIG. 2. When the operation the side-view mirror control mode finishes due to turning-off of a turn signal, the driver 180 may be configured to initialize the position of the adjusted side-view mirror. For example, the driver 180 may be configured to adjust at least one of left and right side-view mirrors from the first angle to the second angle by the operation of the side-view mirror control mode, and then adjust the side-view mirror adjusted to the second angle back to the first angle when the operation of the side-view mirror control mode finishes.

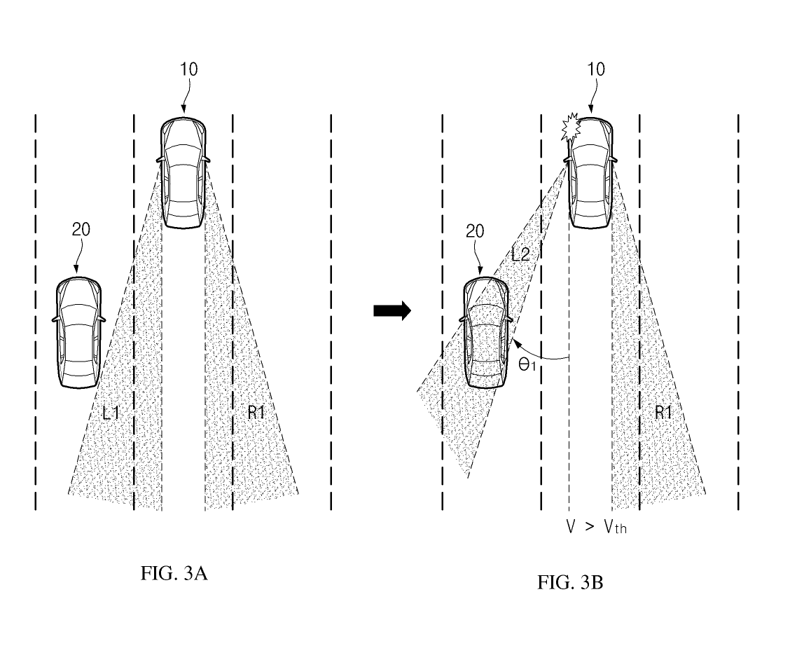

An exemplary embodiment of the operation of changing the positions of side-view mirrors in accordance with the side-view mirror control mode will be described in more detail with reference to FIGS. 3A to 5C. FIG. 2 is an exemplary diagram that is referred to set a side-view mirror control angle of the apparatus for controlling side-view mirrors according to an exemplary embodiment of the present invention.

In FIG. 2, ld is the distance from a side-view mirror of a vehicle 10 to the first point behind the vehicle, l_{w}_{_{—}}ᵢₙᵢₜᵢₐₗ is the distance from the first point to the second point in the lateral direction of the vehicle, l_{w}_{_{—}}_{active} is the distance from the second point to the third point in the lateral direction of the vehicle, θ₀ is the initial view angle of the side-view mirror, and θₗₐₙₑ_{_{—}}_{change} is the adjusted view angle of the side-view mirror. In other words, θ₀ is the first angle used as the initial position of the side-view mirror in the apparatus for controlling a side-view mirror, when the vehicle is driven in a normal driving mode. When the apparatus for controlling a side-view mirror finishes the operation of the side-view mirror control mode, the position of the side-view mirror may be initialized based on the first angle. In the normal driving mode, the position of the side-view mirror may be adjusted manually by the user. θₗₐₙₑ_{_{—}}_{change} is the second angle used for adjusting the side-view mirror in the side-view mirror control mode. Assuming that adjacent vehicle 20 driven in a lane next to the traveling vehicle 10 is positioned at the first distance ld rearward from the vehicle 10, the second angle may be set with respect to the position of the side-view mirror of the vehicle 10 and the substantially center position of the adjacent vehicle 20. The third point may be the substantially center position of the adjacent vehicle 20. In the side-view mirror control mode, the position of the side-view mirrors may be adjusted automatically according to a surrounding environment.

The apparatus for controlling a side-view mirror may calculate θₗₐₙₑ_{_{—}}_{change} from l_{d}, l_{w}_{_{—}}ᵢₙᵢₜᵢₐₗ, l_{w}_{_{—}}_{active}, and θ₀. Refer to the following Equation 1 to calculate θₗₐₙₑ_{_{—}}_{change}.

$${θ}_{lane\_change} = {tan}^{- 1} ( \frac{{l}_{w\_active} {l}_{d}}{{l}_{d}^{2} + {l}_{w\_initial} {l}_{w\_active} + {l}_{w\_initial}^{2}} ) \qquad Equation 1$$

Therefore, the apparatus for controlling a side-view mirror may calculate θₗₐₙₑ_{_{—}}_{change} from Equation 1 and may adjust the position of the side-view mirror to fit to θₗₐₙₑ_{_{—}}_{change} calculated from Equation 1 when the side-view mirror control mode is activated.

When the view angle of the side-view mirror is set to θ₀, the first angle, a driver may have the view from the first point at the first distance, that is, the distance ld rearward from the vehicle to the second point at the second distance, that is, the distance l_{w}_{_{—}}ᵢₙᵢₜᵢₐₗ in the lateral direction. When the view angle of the side-view mirror is set to θₗₐₙₑ_{_{—}}_{change}, the second angle, a driver may have the view angle from the second point to the third point at the third distance, that is, the distance l_{w}_{_{—}}_{active} in the lateral direction. The first angle and the second angle used for controlling the left side-view mirror and the first angle and the second angle used for controlling the right side-view mirror may be the same, respectively, but may be different, depending on exemplary embodiments.

FIGS. 3A to 5C are exemplary diagrams that are referred to illustrate the operation of adjusting the positions of side-view mirrors of the apparatus for controlling side-view mirrors according to an exemplary embodiment of the present invention. FIGS. 3A and 3B show the operation of adjusting the positions of side-view mirrors when a left turn signal is input to change to the left lane.

Referring to FIGS. 3A and 3B, in the apparatus for controlling side-view mirrors, the positions of the left and right side-view mirrors may be set at the initially set view angles while the vehicle 10 is traveling. In particular, as shown in of FIG. 3A, the view area ensured by the left side-view mirror is the area L1 and the view area ensured by the right side-view mirror is the area R1. Since the view area of the left side-view mirror is the area L1, it is impossible to see another vehicle 20 in the left lane through the side-view mirror.

On the other hand, when a left turn signal is input, as in FIG. 3B, the apparatus for controlling side-view mirrors may be configured to determine whether the traveling speed V of the vehicle 10 is greater than a threshold value Vₜₕ. In FIG. 3B, the traveling speed V of the vehicle 10 is greater than the threshold value Vₜₕ, and thus the lane change mode may be activated. When the lane change mode is activated, the apparatus for controlling side-view mirrors, as in FIG. 3B, may be configured to set the left side-view mirror from the first angle to the second angle in response to input of a left turn signal. Accordingly, as the apparatus for controlling side-view mirrors adjusts the view angle of the left side-view mirror, the left side-view mirror may be adjusted left by θ₁ and the view area of L2 may be ensured by the left side-view mirror. Therefore, it may be possible to see the vehicle 20 in the left lane through the left side-view mirror. On the other hand, since the position of the right side-view mirror is not adjusted, the view area R1 may still be ensured.

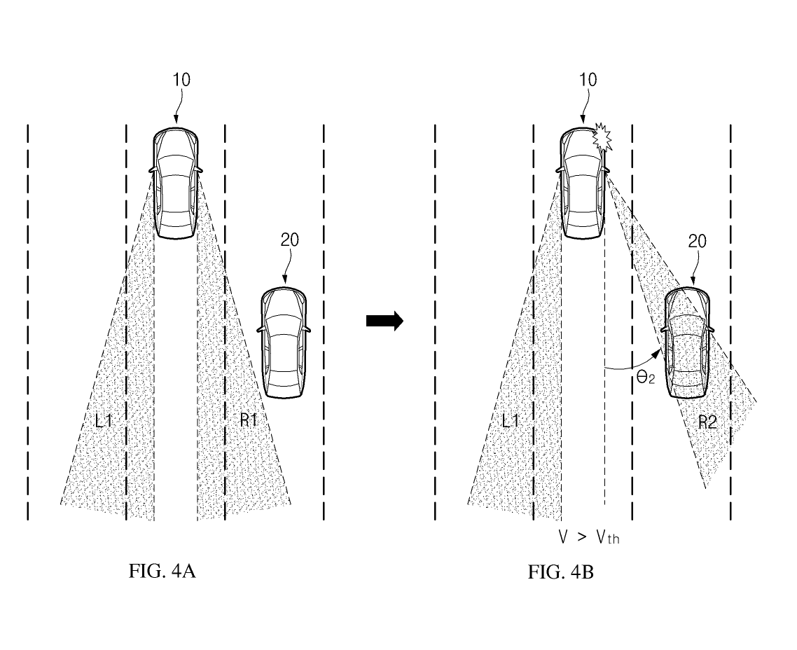

FIGS. 4A and 4B show the operation of adjusting the positions of side-view mirrors when a right turn signal is input to change to the right lane. Referring to FIGS. 4A and 4B, in the apparatus for controlling side-view mirrors, the positions of the left and right side-view mirrors may be set at the initially set view angles while the vehicle 10 is traveling. In particular, as shown in FIG. 4A, the view area ensured by the left side-view mirror is the area L1 and the view area ensured by the right side-view mirror is the area R1. Since the view area of the right side-view mirror is the area R1, it may not be possible to detect another vehicle 20 in the right lane using the side-view mirror.

On the other hand, when a right turn signal is input, as in FIG. 4B, the apparatus for controlling side-view mirrors may be configured to detect whether the traveling speed v of the vehicle 10 is greater than a threshold value Vₜₕ. In FIG. 4B, the traveling speed V of the vehicle 10 is greater than the threshold value Vₜₕ, and thus the lane change mode may be activated. When the lane change mode is activated, the apparatus for controlling side-view mirrors, as in FIG. 4B, may be configured to set the right side-view mirror from the first angle to the second angle in response to input of a right turn signal. Accordingly, as the apparatus for controlling side-view mirrors may be configured to adjust the view angle of the right side-view mirror, the right side-view mirror may be adjusted right by θ₂ and the view area of R2 may be ensured by the right side-view mirror. Therefore, it may be possible to see the vehicle 20 in the right lane using the right side-view mirror. On the other hand, since the position of the left side-view mirror is not adjusted, the view area L1 may still be ensured.

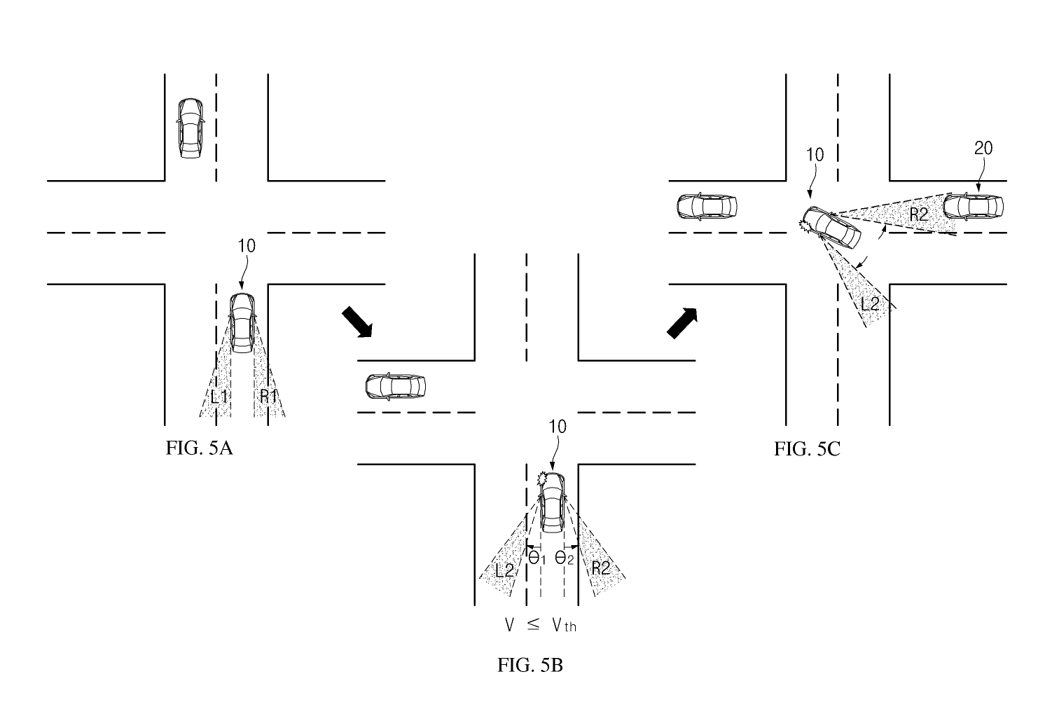

FIGS. 5A to 5C show the operation of adjusting the positions of side-view mirrors when a right turn signal is input to turn a vehicle left. Referring to FIGS. 5A to 5C, in the apparatus for controlling side-view mirrors, the positions of the left and right side-view mirrors may be set at the initially set view angles while the vehicle 10 is traveling. In particular, as shown in FIG. 5A, the view area ensured by the left side-view mirror is the area L1 and the view area ensured by the right side-view mirror is the area R1. Thereafter, when a left turn signal is input, as in FIG. 5B, the apparatus for controlling side-view mirrors may be configured to detect whether the traveling speed v of the vehicle 10 is greater than a threshold value Vₜₕ. In FIG. 5B, since the vehicle 10 is stopped or slows down to a predetermined speed or less to enter a crossroad, the traveling speed V of the vehicle 10 is the threshold value Vₜₕ or less, and thus the vehicle turn mode may be activated.

When the vehicle turn mode is activated, the apparatus for controlling side-view mirrors, as in FIG. 5B, may be configured to set the left and right side-view mirrors from the first angle to the second angle in response to input of a left turn signal. Accordingly, as the apparatus for controlling side-view mirrors adjusts the view angle of the left side-view mirror, the left side-view mirror may be adjusted left by θ₁ and the view area of L2 may be ensured by the left side-view mirror. Further, as the apparatus for controlling side-view mirrors adjusts the view angle of the right side-view mirror, the right side-view mirror may be adjusted right by θ₂ and the view area of R2 may be ensured by the right side-view mirror. When the vehicle 10 turns left, as in FIG. 5C, with the positions of left and right side-view mirrors adjusted, as in FIG. 5B, the driver may have wider view angles using the side-view mirrors with the positions adjusted, to help a driver determine the position of another vehicle entering the crossroad from a distance.

The angle θ₁ used in FIGS. 3B and 5B and the angle θ₂ used in FIGS. 4B and 5B may be the same values but may be different values. When the vehicle 10 finishes moving to the lane to change the lane or passes the crossroad and the turn signal is turned off, the apparatus for controlling side-view mirrors may finish the side-view mirror control mode and adjust the side-view mirrors with the positions adjusted back to the initial positions.

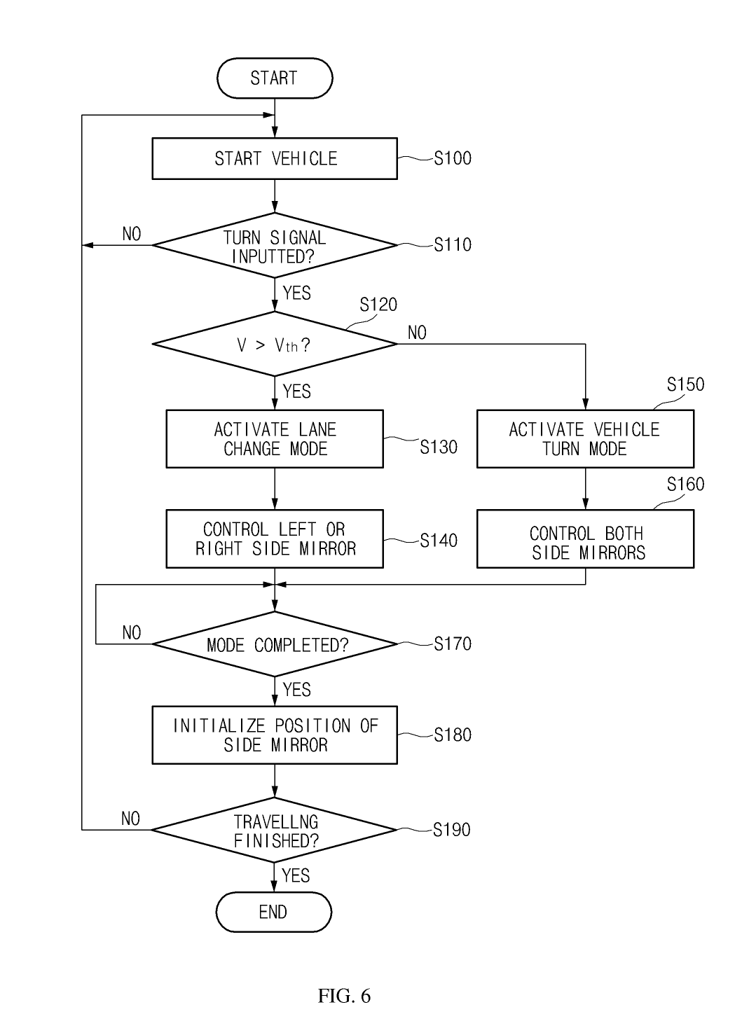

The operation flow in the apparatus for controlling side-view mirrors having the configuration described above, according to an exemplary embodiment of the present invention, is described hereafter in more detail. FIG. 6 is an exemplary flowchart illustrating a method of controlling side-view mirrors according to an exemplary embodiment of the present invention.

Referring to FIG. 6, a controller of the apparatus for controlling side-view mirrors may be configured to determine whether a turn signal is input while a vehicle is traveling (S100). When a turn signal is input (S110), the controller may be configured to detect whether the traveling speed V of the vehicle is greater than a threshold value Vth. When the traveling speed V of the vehicle is greater than the threshold value Vₜₕ (S120), the side-view mirror control mode may be set to the lane change mode and the lane change mode may be activated (S130). When the lane change mode is activated, the controller may be configured to adjust the left or right side-view mirror based on the direction indicated by the turn signal (S140). For example, when a left turn signal is input in S110, the controller may be configured to adjust the position of the left side-view mirror from the first angle to the second angle in S140. Further, for example, when a right turn signal is input in S110, the controller may be configured to adjust the position of the right side-view mirror from the first angle to the second angle in S140.

When the traveling speed V of the vehicle is equal to or less than the threshold value Vₜₕ in S120, the controller may be configured to set the side-view mirror control mode to the vehicle turn mode and activate the vehicle turn mode (S150). When the vehicle turn mode is activated, the controller may be configured to adjust the left or right side-view mirror regardless of the direction indicated by the turn signal (S160). In other words, the controller may be configured to adjust the positions of the left and right side-view mirrors from the first angle to the second angle in S160. When the position adjustment angles of the left and right side-view mirrors are set differently, the positions of the side-view mirrors may be adjusted based on the position adjustment angles set for the left and right side-view mirrors.

However, it may be assumed that the first angle is set closer to the vehicle than the second angle. When the positions of the side-view mirrors are adjusted in S140 or S160 (S170), the controller may be configured to initialize the positions of the side-view mirrors (S180). For example, when the vehicle changes to the left or right lane and the left turn signal or the right turn signal is turned off, the controller may be configured to end the operation of the lane change mode and initialize the position of the left or right side-view mirror. Further, when the vehicle passes a crossroad and the input of a turn signal is turned off in the vehicle turn mode, the controller may be configured to end the operation of the vehicle turn mode and initialize the positions of the left and right side-view mirrors. The processes of S100 to S180 may be repeated when a turn signal is generated while a vehicle is traveling and the controller may be configured to end the associated operation when the vehicle stops.

As set forth above, according to the present invention, side views of a driver may be ensured appropriately by determining that a vehicle changes a lane or turns based on the traveling speed of the vehicle when a turn signal is input and automatically adjusting the position of at least one of left and right side-view mirrors based on the determination.

The above description is an example that explains the spirit of the present invention and may be changed and modified in various ways without departing from the basic features of the present invention by those skilled in the art. Accordingly, the exemplary embodiment described herein are provided not to limit, but to explain the spirit of the present invention and the spirit and the scope of the present invention are not limited by the exemplary embodiments. The protective range of the present invention should be construed based on claims and all the technical spirits in the equivalent range should be construed as being included in the scope of the right of the present invention.

What is claimed is:

1. An apparatus for controlling side-view mirrors, the apparatus comprising:
a memory configured to store program instructions; and
a processor configured to execute the program instructions, the program instructions when executed configured to:
determine whether a turn signal is input from vehicle information collected while a vehicle is traveling;
detect a traveling speed when a turn signal is input to determine a control mode of side-view mirrors based on the traveling speed of the vehicle;
adjust a position of a left or right side-view mirror based on the turn signal when the control mode of the side-view mirrors is set to a lane change mode; and
adjust the position of the left or right side-view mirror when the control mode of the side-view mirrors is set to a vehicle turn mode.

2. The apparatus according to claim 1, wherein the program instructions when executed are configured to determine the control mode of the side-view mirrors as the lane change mode when the traveling speed is greater than a predetermined threshold value with the turn signal input.

3. The apparatus according to claim 1, wherein the program instructions when executed are configured to set the control mode of the side-view mirrors to the vehicle turn mode when the traveling speed is less than a predetermined threshold value with the turn signal input.

4. The apparatus according to claim 1, wherein the program instructions when executed are configured to determine whether the input turn signal is a left turn signal or a right turn signal when the turn signal is input.

5. The apparatus according to claim 4, wherein the position of the left side-view mirror is adjusted when the control mode of the side-view mirrors is set to the lane change mode with the left turn signal input, and the position of the right side-view mirror is adjusted when the control mode of the side-view mirrors is set to the lane change mode with the right turn signal input.

6. The apparatus according to claim 1, wherein a view angle of a side-view mirror is changed from a first angle determined on a line parallel to a side of the vehicle to a second angle moved from the first angle in the lateral direction, when the turn signal is input and the control mode of the side-view mirrors is determined.

7. The apparatus according to claim 6, wherein the first angle is formed by a first point at a first distance from a side-view mirror of the vehicle rearward and a second point at a second distance from the first point in the lateral direction of the vehicle, and the second angle is formed by the second point and a third point at a third distance from the second point in the lateral direction of the vehicle.

8. The apparatus according to claim 1, wherein the adjusted positions of the side-view mirrors are initialized when the operation of the control mode of the side-view mirrors is completed.

9. A method of controlling side-view mirrors, the method comprising:
determining, by a controller, whether a turn signal is input while a vehicle is traveling;
determining, by the controller, whether the input turn signal is a left turn signal or a right turn signal when a turn signal is input;
comparing, by the controller, the traveling speed of the vehicle with a predetermined threshold value when the turn signal is input;
determining, by the controller, the control mode of the side-view mirrors based on the comparison result;
adjusting, by the controller, a position of a left or right side-view mirror based on the turn signal when the control mode of the side-view mirrors is set to a lane change mode; and
adjusting, by the controller, the positions of the left and right side-view mirrors when the control mode of the side-view mirrors is set to a vehicle turn mode.

10. The method according to claim 9, wherein the determination of the control mode of the side-view mirrors includes:
setting, by the controller, the control mode of the side-view mirrors to the lane change mode when the traveling speed is greater than the predetermined threshold value with the turn signal input; and
setting, by the controller, the control mode of the side-view mirrors to the vehicle turn mode when the traveling speed is less than the threshold value with the turn signal input.

11. The method according to claim 9, further comprising:
initializing, by the controller, the adjusted positions of the side-view mirrors when the operation of the control mode of the side-view mirrors is completed.

12. A non-transitory computer readable medium containing program instructions executed by a controller, the computer readable medium comprising:
program instructions that determine whether a turn signal is input while a vehicle is traveling;
program instructions that determine whether the input turn signal is a left turn signal or a right turn signal when a turn signal is input;
program instructions that compare the traveling speed of the vehicle with a predetermined threshold value when the turn signal is input;
program instructions that determine the control mode of the side-view mirrors based on the comparison result;
program instructions that adjust a position of a left or right side-view mirror based on the turn signal when the control mode of the side-view mirrors is set to a lane change mode; and
program instructions that adjust the positions of the left and right side-view mirrors when the control mode of the side-view mirrors is set to a vehicle turn mode.

13. The non-transitory computer readable medium of claim 12, wherein the determination of the control mode of the side-view mirrors includes:
program instructions that set the control mode of the side-view mirrors to the lane change mode when the traveling speed is greater than the predetermined threshold value with the turn signal input; and
program instructions that et the control mode of the side-view mirrors to the vehicle turn mode when the traveling speed is less than the threshold value with the turn signal input.

14. The non-transitory computer readable medium of claim 12, further comprising:
program instructions that initialize the adjusted positions of the side-view mirrors when the operation of the control mode of the side-view mirrors is completed.
